(19) United States
(12) Patent Application Publication
(10) Pub. No.: US 2007/0169907 A1
(43) Pub. Date: Jul. 26, 2007

(54) PROCESS BELT WITH FILLED SURFACE DEPRESSIONS

(75) Inventors: Arved H. WESTERKAMP, Dettingen/Erms (DE); Matthias SCHMITT, Munich (DE)

Correspondence Address: GREENBLUM & BERNSTEIN, P.L.C., 1950 ROLAND CLARKE PLACE, RESTON, VA, 20191, US

(73) Assignee: VOITH PATENT GMBH, Heidenheim (DE)

(21) Appl. No.: 11/626,663

(22) Filed: Jan. 24, 2007

(30) Foreign Application Priority Data
Jan. 26, 2006 (DE) 10 2006 003 707.3

(51) Int. Cl. D21F 3/02; B32B 5/02

(52) U.S. Cl. 162/205; 442/59; 34/117

(57) ABSTRACT

A transport belt, in particular for machines for the production of web material such as paper or paperboard, the transport belt including a web material contact side having surface depressions, such that the surface depressions are filled with filler material to provide a substantially flat web material contact surface.

### CROSS-REFERENCE TO RELATED APPLICATIONS

The present application claims priority under 35 U.S.C. § 119 of German Patent Application No. 10 2006 003 707.3, filed Jan. 26, 2006, the disclosure of which is expressly incorporated by reference herein in its entirety.

### BACKGROUND OF THE INVENTION

1. Field of the Invention

This invention relates to a transport belt such as can be used on machines for the production of web material for example, such as paper or paperboard for example.

2. Background and Related Information

Transport belts of this type are used in the production of paper, for example in regions in which the still wet paper material is passed through press sections in order to remove liquid still present in the material. En route through two press rollers for example there forms between the transport belt and the web material, meaning the paper or the starting material for the paper, a thin liquid film from the water pressed out of said material. Generally the transport belt is impermeable to water in order to provide as smooth a surface as possible and produce an accordingly unstructured image of this surface on the web material; hence the problem arises at the point where the transport belt is separated from web material that the existing thin film of liquid or water produces an adhesive effect. This impairs the releasing of the transport belt from the web material.

A method known from U.S. Pat. No. 6,962,885 B1, incorporated by reference herein in its entirety, to combat this problem is to provide, on the side of the transport belt which comes into contact with the web material, a thin layer which does not have a flat or smooth surface structure but a multiplicity of small depressions. The latter can be formed during the production of this thin layer by embedding grains of salt in the material. Where the gains of salt are not fully embedded they can be subsequently removed by dissolving in water, thus obtaining hollow spaces or depressions open to the surface. Water pressed out of the web material can be collected in these depressions and the adhesive effect can be at least lessened.

An approach known from EP 0 576 115 B1, incorporated by reference herein in its entirety, is for the surface of the transport belt which comes into contact with the web material to be provided with a comparatively rough structure and at the same time to form this region of the transport belt from an elastic material. When it is being pressed between two press rollers the comparatively rough surface is compressed. After it has passed through this press roller region the compressed transport belt relaxes, with the result that the serrated elevations forming the surface roughness create a disturbance in the existing water film, thus making it easier for the transport belt to separate from the web material.

### SUMMARY OF THE INVENTION

An aspect of the present invention is to provide a transport belt, in particular for machines for the production of web material such as paper or paperboard, with which it is possible to produce web material of high quality without the risk of unwanted adhesion.

The present invention provides a transport belt for machines for the production of web material such as paper or paperboard, including a web material contact side having surface depressions, wherein the surface depressions are filled with filler material to provide a substantially flat web material contact surface.

In one embodiment, the approach taken by the present invention is to render the surface of the transport belt which comes into contact with the web material, meaning the web material contact surface, flat or smooth, meaning to create the fewest possible elevations or depressions that could subsequently be reproduced in the web material. However, the problem with such a flat or smooth surface would then be that, like a thin film of water between two smooth panes of glass, a very strong and unwelcome adhesive effect could arise. This is counteracted by the current invention in that surface regions are provided, locally restricted, by the filler material existing in the surface depressions. Although a smooth surface is created as the result, it is provided by surface regions with various surface properties, namely those surface regions in which the filler material exists and those surface regions in which there are no surface depressions filled with filler material. This distribution creates, locally, regions with various surface energies, with the result that because of local disturbances or differences in the interaction with the water film, said film is easier to tear when separating the transport belt from the web material.

In this case provision can be made, for example, for the surface depressions to form, at least in some regions, a substantially regular pattern of depressions. Alternatively or in other locally restricted regions provision can be made for the surface depressions to form, at least in some regions, an irregular pattern of depressions.

So that the previously mentioned locally differentiated properties of interaction of the transport belt with the water film or the web material can be generated in easy manner it is proposed for the filler material to differ in its surface properties from the material of the transport belt in which the surface depressions are formed. This includes the use of fundamentally different materials for example. Identical or at least similar materials which are differently treated or which give rise to different surface properties due to different production techniques can also be used.

For example, in some embodiments, the filler material can comprise polymer material such as silicone material or fluoropolymer material for example.

In some embodiments, the material of the transport belt in those regions in which the surface depressions holding the filler material exist can comprise polyurethane material for example.

The surface depressions can be created by mechanical, thermal or chemical methods for example, such as grinding, embossing or etching for example. Combinations of several of these methods are also possible of course.

The present invention also provides a method for manufacturing a transport belt for machines for the production of web material such as paper or paperboard, the method including structuring a web material contact side of a transport belt with surface depressions, and filling the surface depressions with a filler material to provide a substantially flat web material contact surface.

In some embodiments, the surface depressions in the method of manufacturing a transport belt can be created by at least one of mechanical, thermal or chemical methods. For example, in some embodiments the mechanical method of creating the surface depressions can include grinding, the thermal method of creating the surface depressions can include embossing, and the chemical method of creating the surface depressions can include etching.

### BRIEF DESCRIPTION OF THE DRAWINGS

The present invention is further described in the detailed description which follows, in reference to the noted plurality of drawings by way of non-limiting examples of preferred embodiments of the present invention, in which like numerals represent like elements throughout the several views of the drawings, and wherein:

FIG. 1 is a schematic sectional view of a transport belt according to an embodiment of the present invention;

FIG. 2 is a plan view of part of the transport belt from FIG. 1 looking in the direction II in FIG. 1; and

FIG. 3 shows a representation of an alternative embodiment corresponding to FIG. 1.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

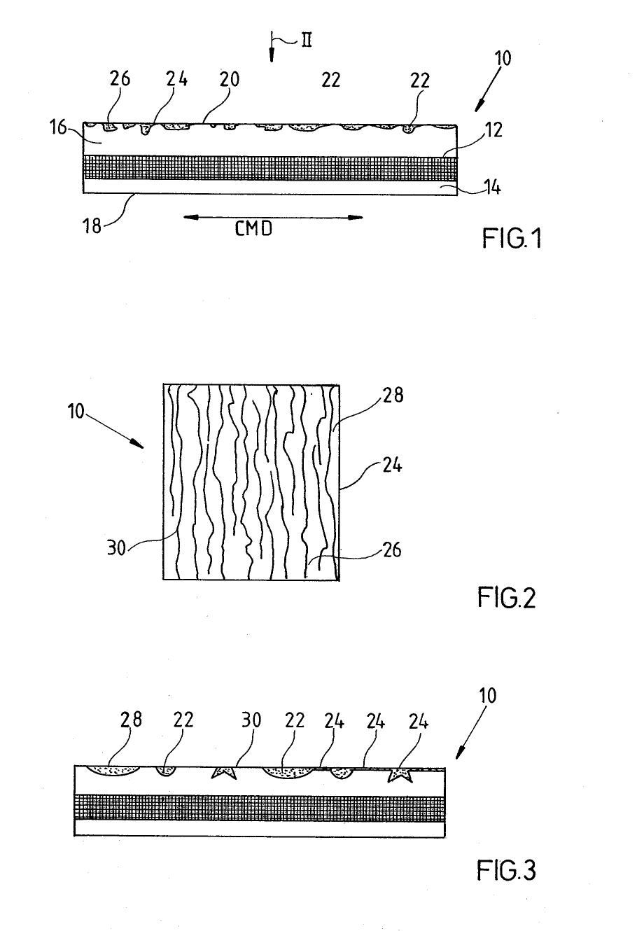

Referring to the drawings wherein like numerals represent like elements, FIG. 1 is a schematic and sectional view of a transport belt according to the invention. It should be noted that the evident proportions are not true to original. The extension of such a transport belt in the cross machine direction (CMD) is generally greater by many orders of magnitude than the thickness of the transport belt. However, the thickness and in particular also the structuring in the thickness direction, meaning in upwards/downwards direction in the representation in FIG. 1, are exaggerated in order to illustrate the essential aspects of the invention.

The transport belt 10 has in a central region a reinforcement 12 which provides the essential strength in the transverse direction (i.e., cross machine direction, or CMD) as well as in the longitudinal direction and which can be created by a fabric or some other fiber- or tape-like material. This reinforcement 12 is generally embedded in and surrounded on both sides by construction material 14, 16, which creates the essential volume of the transport belt. This construction material can be comprised of several layers in order to provide the desired properties. For example, on the rear side 18 of the transport belt 10 lying at the bottom in FIG. 1 the construction material 14 used could be a material capable of meeting the special requirements imposed by contact with guide or drive elements. On the web material contact side 20 provided for contacting the web material the construction material 16 or its near-surface region is structured by providing a multiplicity of surface depressions 22. As shown in FIG. 2, these surface depressions 22 can be constructed to extend essentially in the longitudinal direction. In this case the depth of these depressions can lie in the range up to 50 μm for example.

In order to provide on the web material contact side 20 a substantially flat, meaning smooth, web material contact surface 24 which is not disturbed by the comparatively rough structuring of the depressions 22, the surface depressions 22 are filled with filler material 26. Together with those regions of the construction material 16 lying between the surface depressions 22, this filler material 26 forms a substantially unprofiled, smooth web material contact surface 24 which has a surface roughness of less than R_{z} of 2 for example. However, the result in the web material contact surface 24 is the picture, evident in FIG. 2, of surface regions 28 in which the web material contact surface 24 is formed by the filler material 26 and, therebetween, line-like surface regions 30 in which the web material contact surface 24 is provided by the construction material 16 in which the surface depressions 22 are formed.

Although the inventively constructed transport belt 10 thus provides a smooth surface and hence a surface which produces an accordingly unstructured web material, the transport belt 10 displays, as the result of the various surface regions 28, 30, various characteristics in its interaction with a liquid film, for example water film, created between a web material to be produced and the web material contact surface 24. In particular when materials of different surface energy or different hydrophility or hydrophobity are used for the construction material 16 on the one hand and the filler material 26 on the other hand, the various surface regions 28, 30 give rise locally to disturbances which result, in that area of a production process in which the transport belt 10 must be separated from the web material to be produced, in a far easier tearing of the water film than compared to a uniform surface. Given a very smooth web material contact surface 24 and an accordingly reduced marking problem, the easier releasing of the transport belt enables a production process with higher quality.

The construction material 16 used can be a polyurethane material for example. The surface depressions 22 can be provided in this polyurethane material by, for example, an embossing operation, a grinding operation, a corresponding casting operation or extrusion operation, or also by using a surface-etching material if required. Silicone material or fluoropolymer material for example can then be applied as filler material to the profiled or structured surface thus produced. The different surface properties in the regions 28, 30 can be further influenced by various additives in the filler material 26 on the one hand or in the construction material 16 on the other hand in order to create the desired characteristics in the production process. The filler material which is to be applied onto the construction material 16 and into the surface depressions 22 can be applied by spreading on a thin material film and peeling it off again before it fully hardens, thus providing the flat, inherently closed and substantially unstructured surface. It is also possible, for example, to also use various filler materials in different local regions of such a transport belt in order to more greatly emphasize the effect of varying the surface properties.

On the embodiment presented in FIGS. 1 and 2, the surface depressions 22 and the elevations between them are constructed to extend basically in longitudinal direction but more or less randomly or statistically distributed. Depending on the requirements it may also be desirable however to generate a more regular depression pattern or surface pattern. This is shown in FIG. 3. Here is a pattern, for example, of surface depressions 22 extending likewise in the longitudinal direction of the belt 10, which although they can be shaped differently to each other are nevertheless arranged in a regular pattern. The filler material 24 is applied into these surface depressions 22 such that the surface regions 28 and 30 are again generated on the web material contact surface 24 of the transport belt 10. Needless to say it is also possible for such a line-like pattern to be provided with an essential direction of extension in the transverse direction CMD. A dot-like depression pattern can also be used.

Finally it should again be noted that the basic principle of the invention is of course applicable essentially independently of how the essential volume of the transport belt 10 is constructed. As previously explained, the construction material 16 can be constructed from multiple layers, and the reinforcement 12 embedded therein can also be constructed from various materials such as fabrics, knittings, long or short individual fibers, wound or helical thread elements or the like which are optimally adapted to the existing requirements.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

Further, when an amount, concentration, or other value or parameter, is given as a list of upper preferable values and lower preferable values, this is to be understood as specifically disclosing all ranges formed from any pair of an upper preferred value and a lower preferred value, regardless whether ranges are separately disclosed.

What is claimed:

1. A transport belt for machines for the production of web material such as paper or paperboard, comprising:
a web material contact side having surface depressions,
wherein the surface depressions are filled with filler material to provide a substantially flat web material contact surface.

2. The transport belt according to claim 1, wherein the surface depressions form, at least in some regions, a substantially regular pattern of depressions.

3. The transport belt according to claim 1, wherein the surface depressions form, at least in some regions, a substantially irregular pattern of depressions.

4. The transport belt according to claim 1, wherein the filler material differs in its surface properties from the material of the transport belt in which the surface depressions are formed.

5. The transport belt according to claim 2, wherein the filler material differs in its surface properties from the material of the transport belt in which the surface depressions are formed.

6. The transport belt according to claim 3, wherein the filler material differs in its surface properties from the material of the transport belt in which the surface depressions are formed.

7. The transport belt according to claim 4, wherein the filler material comprises polymer material, preferably silicone material or fluoropolymer material.

8. The transport belt according to claim 6, wherein the material of the transport belt, in which the surface depressions are formed, comprises polyurethane material.

9. The transport belt according to claim 7, wherein the material of the transport belt, in which the surface depressions are formed, comprises polyurethane material.

10. The transport belt according to claim 1, wherein the surface depressions are created by mechanical, thermal or chemical methods.

11. A method of manufacturing a transport belt for machines for the production of web material such as paper or paperboard, the method comprising:
structuring a web material contact side of a transport belt with surface depressions, and
filling the surface depressions with a filler material to provide a substantially flat web material contact surface.

12. The method according to claim 11, wherein the surface depressions are created by at least one of mechanical, thermal or chemical methods.

13. The method according to claim 12, wherein the mechanical method of creating the surface depressions comprises grinding.

14. The method according to claim 12, wherein the thermal method of creating the surface depressions comprises embossing.

15. The method according to claim 12, wherein the chemical method of creating the surface depressions comprises etching.
